(19) United States
(12) Patent Application Publication
(10) Pub. No.: US 2017/0045022 A1
(43) Pub. Date: Feb. 16, 2017

(54) System Configured to Pump Fuel

(71) Applicant: Caterpillar Inc., Peoria, IL (US)

(72) Inventors: Joshua Wayne Steffen, El Paso, IL (US); Sunil Bean, Peoria, IL (US); Cory Andrew Brown, Peoria, IL (US); Robert Campion, Chillicothe, IL (US)

(73) Assignee: Caterpillar Inc., Peoria, IL (US)

(21) Appl. No.: 14/824,919

(22) Filed: Aug. 12, 2015

(51) Int. Cl. F02M 37/04; F02M 37/00

(52) U.S. Cl. CPC F02M 37/04; F02M 37/0047

(57) ABSTRACT

A fuel pump system configured to control a pressure pulse within a fuel system. The fuel pump system includes a conduit and a pump fluidly coupled to the conduit. The conduit has a conduit volume and is configured to contain fuel within. The pump includes a first pump stage in which the pump defines a maximum pump displacement and a second pump stage in which the pump defines a minimum pump displacement. The pump is configured to provide an output mass of fuel to the conduit when the pump transitions from the first pump stage to the second pump stage, causing pressure of the fuel within the conduit to pulse. The maximum pump displacement is set to a value defined by a ratio of the output mass of fuel per the conduit volume needed to maintain the pressure pulse in the conduit within a predetermined pressure pulse range.

### TECHNICAL FIELD

This disclosure relates generally to fuel systems, and more particularly, to a fuel pump system used to control pressure pulses within a fuel system.

### BACKGROUND

Natural gas vehicles can provide reduced fuel costs and reduced greenhouse gas emissions compared with vehicles that use conventional fuels. Natural gas vehicles are used in, for example, automobile, over-the-road trucking, off-road trucking, marine, and locomotive applications. Natural gas vehicles include fuel supply systems that are different from fuel supply systems for gasoline or diesel engines. Natural gas fuel supply systems, such as a high pressure gas system for direct injection, use a fuel pump to supply natural gas to a cylinder of an engine from a storage tank. To control the flow of the natural gas, the fuel supply system often has at least one of several components, including an accumulator, a vaporizer, a regulator, or the like. Each of the components may be incorporated to control aspects of the fuel flow, such as the flow rate, fuel pressure, fuel temperature, or other aspects.

Current fuel supply systems have attempted to reduce the number of components by controlling fuel flow rates and/or modifying the fuel pump. U.S. Pat. No. 6,659,730 describes a pump system that uses two operating modes to supply natural gas from a storage tank to a fuel pump having multiple chambers. Each operating mode is designed to achieve a mass flow rate by supplying the multiple compression chambers with a liquid and/or vapor mixture. Although this system reduces the number of components within the fuel supply system, the fuel pump includes multiple chambers, multiple check valves, and other components configured to control the state of the fuel; therefore, introducing complexities.

Thus, an improved and/or simplified fuel supply system for controlling the flow of fuel to an engine is desired.

### SUMMARY

An aspect of the present disclosure provides a fuel system having a fuel conduit and a pump fluidly coupled together. The fuel conduit has a conduit volume and is configured to contain a fuel at a plurality of fuel states. The pump has a pump displacement and is configured to transition the fuel within the fuel conduit from a first of the plurality of fuel states to a second of a plurality of fuel states by providing an output mass of fuel to the fuel conduit. The first of the plurality of fuel states includes first fuel pressure and the second of the plurality of fuel states includes a second fuel pressure. The pump displacement is set based on the output mass of fuel per the conduit volume needed to achieve a predetermined pressure pulse of the fuel within the conduit volume. The predetermined pressure pulse is a difference between the first fuel pressure and the second fuel pressure.

Another aspect of the present disclosure provides a fuel system having an engine, a fuel conduit, and a pump. The engine is fluidly coupled to the pump via the fuel conduit. The fuel conduit is configured to contain a fuel at a plurality of fuel states. The pump has a pump volume and is configured to transition the fuel within the accumulator from a first of the plurality of fuel states to a second of the plurality of fuel states by providing an output mass of fuel to the accumulator. The first of the plurality of fuel states includes a first fuel pressure and the second of the plurality of fuel states includes a second fuel pressure. The pump volume is set based on the output mass of fuel per the accumulator volume needed to achieve a predetermined pressure pulse of the fuel within the accumulator. The predetermined pressure pulse is a difference between the first fuel pressure and the second fuel pressure.

Another aspect of the present disclosure provides a machine having an engine and a fuel system fluidly coupled together. The fuel system includes a fuel conduit and a pump. The fuel conduit has a conduit volume and is fluidly coupled to the engine. The fuel conduit is configured to contain a fuel at a plurality of fuel states. The pump is fluidly coupled to the fuel conduit and configured to transition the fuel within the accumulator from a first of the plurality of fuel states to a second of the plurality of fuel states by providing an output mass of fuel per conduit volume to the fuel conduit. The first of the plurality of fuel states includes a first fuel pressure and the second of the plurality of fuel states includes a second fuel pressure. The output mass of fuel per conduit volume is set based on a predetermined pressure pulse of the fuel. The predetermined pressure pulse is a difference between the first fuel pressure and the second fuel pressure.

### BRIEF DESCRIPTION OF THE DRAWINGS

FIG. 1 is a side view of a machine, according to an aspect of this disclosure.

FIG. 2 is a schematic of a fuel system including a fuel pump, according to an aspect of this disclosure.

FIG. 3 is a side view of a cross section of the fuel pump illustrated in FIG. 2, along line 3-3, according to an aspect of this disclosure.

FIG. 4 is a cross section of one end of the fuel pump illustrated in FIG. 3, according to an aspect of this disclosure.

FIG. 5 is a graph depicting a first fuel pressure pulse, according to an aspect of this disclosure.

FIG. 6 is a graph depicting a second fuel pressure pulse, according to an aspect of this disclosure.

### DETAILED DESCRIPTION

The disclosure relates generally to a fuel system configured to pump fuel into an engine. The fuel system may include a fuel pump having a plurality of pumping elements, each of which is configured to pump a mass of fuel from a fuel reservoir into the engine via a fuel conduit. Each of the pumping elements includes a pump volume that is set to a value defined by a ratio of the output mass of fuel per a volume of the fuel conduit needed to achieve a predetermined pressure pulse of the fuel within the conduit.

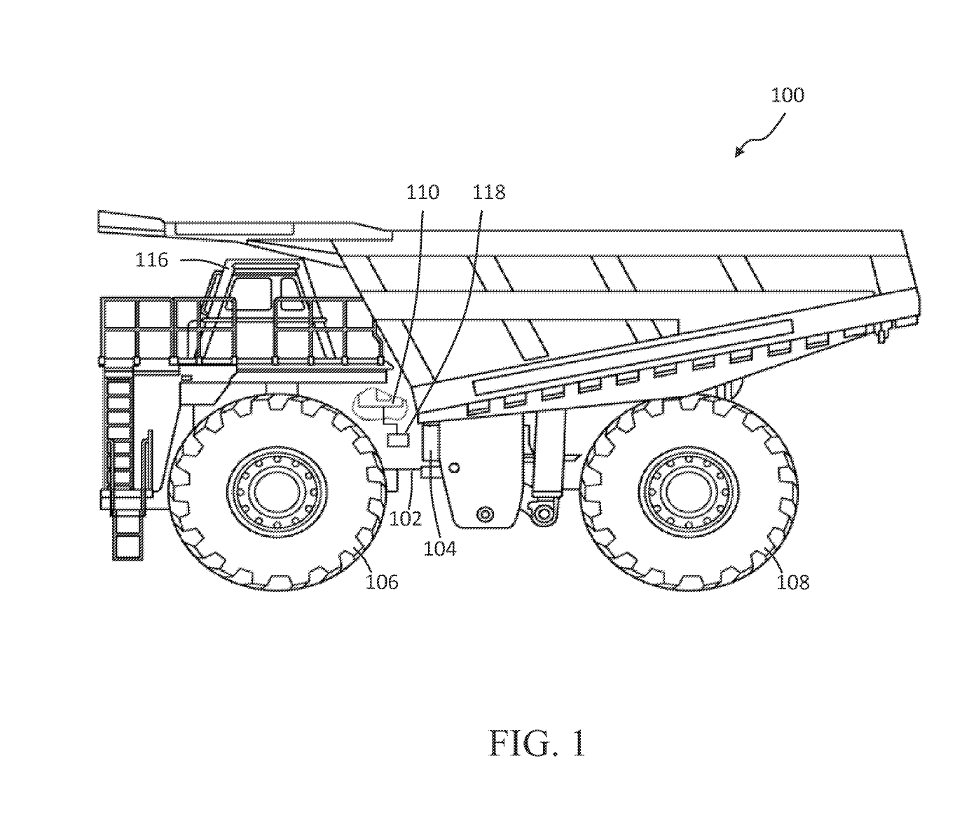

FIG. 1 illustrates a machine 100, according to an aspect of this disclosure. The machine 100 may be a mining truck, as shown, or may include any other on-highway or off-highway vehicle such as a locomotive. In the illustrated aspect, the machine 100 includes a machine body 102 having a drive system 104 supported thereon configured to rotate front wheels 106 and/or rear wheels 108 of the machine 100. The drive system 104 may receive power from an internal combustion engine 110, or other power source, and transmit the power to one or more ground engaging elements, such as the front wheels 106, the rear wheels 108, or both. The drive system 104 may also include a transmission, a torque converter, a final drive assembly, or the like.

To facilitate control and coordination of the machine 100, the machine 100 may include a controller 118, such as an electronic controller, system computer, central processing unit, or other data storage and manipulation device known in the art. The controller 118 may be used to facilitate control and coordination of any methods or procedures described herein. Components of the controller 118 may include, for example, a processor, memory, and a display that may be housed in an operator control station 116, on the machine 100, located remotely, or any combination thereof. While the controller 118 is illustrated as a single unit, in other aspects the controller 118 may be distributed as a plurality of distinct but interoperating units, incorporated into another component, or located at different locations on or remote from the machine 100.

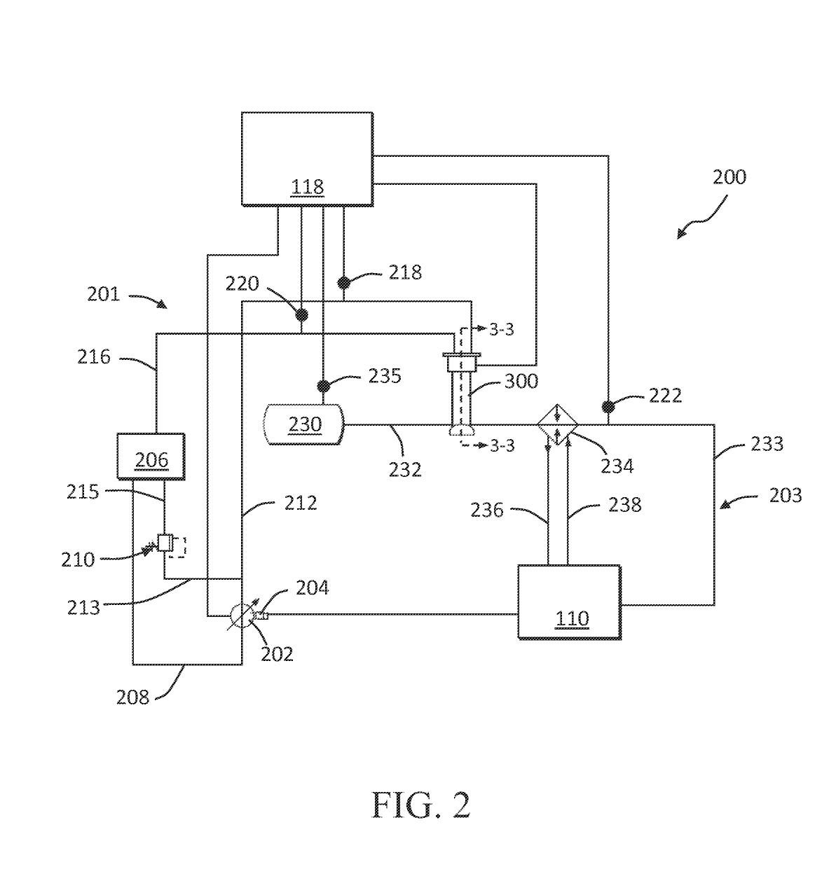

FIG. 2 illustrates a schematic of a fuel system 200 that may be incorporated into the machine 100 configured to provide fuel to the engine 110. The fuel system 200 may include a hydraulic fluid flow path 201 and a fuel flow path 203.

The hydraulic fluid flow path 201 may include a hydraulic pump 202 coupled to the engine 110 via a drive shaft 204 or other suitable coupling element, a hydraulic fluid reservoir 206, or other components configured to facilitate hydraulic fluid flow. The hydraulic pump 202 receives hydraulic fluid from the hydraulic fluid reservoir 206 via a reservoir conduit 208. The hydraulic pump 202 may then deliver the hydraulic fluid to a fuel pump 300 via a pump conduit 212. A return conduit 216 provides fluid communication between the fuel pump 300 and the hydraulic reservoir 206.

When the hydraulic pump 202 delivers hydraulic fluid flow through the pump conduit 212, pressure in the pump conduit 212 may increase thereby causing a pressure increase in a first connecting conduit 213. The pressure increase in the first connecting conduit 213 may cause a pressure release valve 210 to transition from a closed position to an open position providing communication between the hydraulic reservoir 206 and the pump conduit 212 via the first connecting conduit 213 and a second connecting conduit 215.

In an aspect of this disclosure, a directional control valve (not shown) may be positioned along the pump conduit 212 and/or the return conduit 216. The controller 118 may be operatively coupled to the directional control valve and configured to control the flow of hydraulic fluid to and from the fuel pump 300.

The fuel flow path 203 may include a fuel storage tank 230, the fuel pump 300, a vaporizer 234, the engine 110, or other components commonly used to pump fuel through a fuel system. The fuel pump 300 may be used to deliver cryogenic fluid, such as liquefied natural gas (LNG), from the fuel storage tank 230 through a first fuel conduit 232, a second fuel conduit 233, and the vaporizer 234 to the engine 110. In an aspect of this disclosure, the fuel pump 300 may be a liquefied natural gas cryogenic fuel pump. The fuel storage tank 230 may be an insulated tank, such as a vacuum insulated tank or cryogenic tank. A pressure sensor 235 may be positioned to measure fuel pressure within the fuel storage tank 230 and, as such, may be positioned at least partially within the storage tank 230. In an aspect of this disclosure, the fuel pump 300 may be positioned within the fuel storage tank 230 such that the pump 300 is configured to draw the fuel from the storage tank 230. Energy may be supplied to the vaporizer 234 by engine coolant that flows from and to the engine 110 via coolant conduits 236 and 238.

In an aspect of this disclosure, an accumulator (not shown) may be positioned along the second fuel conduit 233 to facilitate the flow of fuel to the engine 110. The accumulator may store fuel until the pressure within the accumulator reaches a predetermined threshold, at which point the fuel is released and flows through the second fuel conduit 233 and into the engine 110. The accumulator may also be configured to dampen out pressure fluctuations of fuel within the second fuel conduit 233.

In other aspects, the fuel system 200 may include various components commonly used in fuel systems, such as, for example, sensors, actuators, thermal fuses, shut-off valves, check valves, vent valves, fuel filters, heat exchangers, or the like. These components may be incorporated throughout the fuel system 200 to monitor, control, or otherwise facilitate the flow of fuel.

The pump conduit 212, the return conduit 216, and the second fuel conduit 233 may each include at least one sensor 218, 220, and 222, respectively. Each of the at least one sensors 218, 220, and 222 may be coupled to the controller 118 and configured to sense a pressure, a temperature, or collect other data that may be used to control the flow of hydraulic fluid into the fuel pump 300 and/or control the flow of fuel into the engine 110. In other aspects, fewer or more sensors may be coupled to the fuel system 200.

The controller 118 may be operatively coupled to each of the at least one sensors 218, 220, and 222, the pressure sensor 235, the fuel pump 300, and the engine 110 to receive and transmit information. The information received from each of the at least one sensors 218, 220, and 222, the pressure sensor 235, the fuel pump 300, and the engine 110 may be stored as values in a computer readable memory, and used to control aspects of the fuel system 200, such as, for example, the flow rate, the pressure, and the temperature of the fuel and hydraulic fluid. In alternative aspects, the controller 118 may be operatively coupled to various other components, including, for example, actuators, gauges, indicators, or additional sensors, configured to facilitate control and coordination of the machine 100.

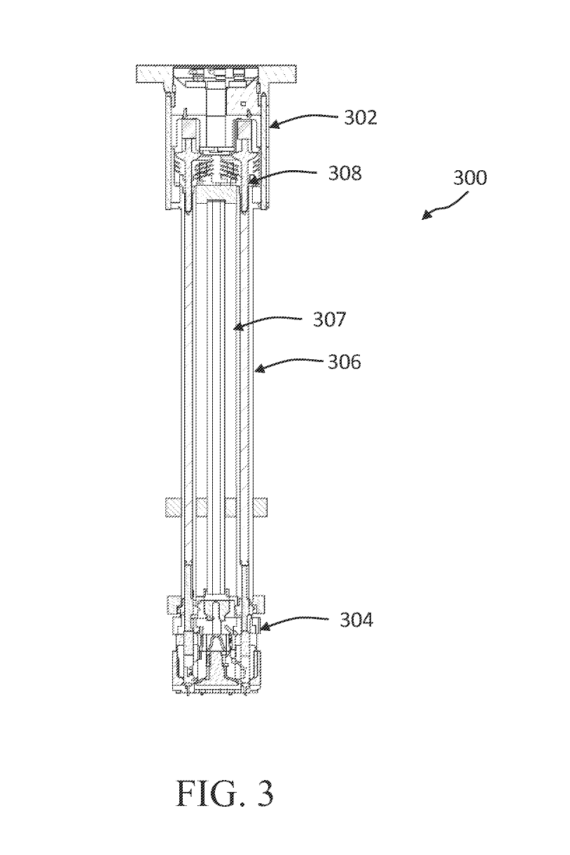

FIG. 3 illustrates a side view of a cross section of the fuel pump 300 illustrated in FIG. 2, along line 3-3, according to an aspect of this disclosure. The fuel pump 300 includes a first end 302, a second end 304, and a middle section 306. The fuel pump 300 may also include a tank socket (not shown) used for insertion of the fuel pump 300 into the fuel storage tank 230. The middle section 306 may include connecting rods 307 configured to connect the first end 302 of the fuel pump 300 to the second end 304 of the fuel pump 300. The first end 302 may include a pump drive system 308 configured to generate a reciprocating force that drives the second end 304 via the connecting rods 307. In an aspect of this disclosure, the pump drive system 308 may be a hydraulic drive system or other drive system known in the art. In an aspect of this disclosure, the fuel pump 300 may include one or more connecting rods 307, commonly four, six, or eight, each configured to transmit the reciprocating force from the first end 302 to the second end 304. In a preferred aspect, the fuel pump 300 includes six connecting rods 307.

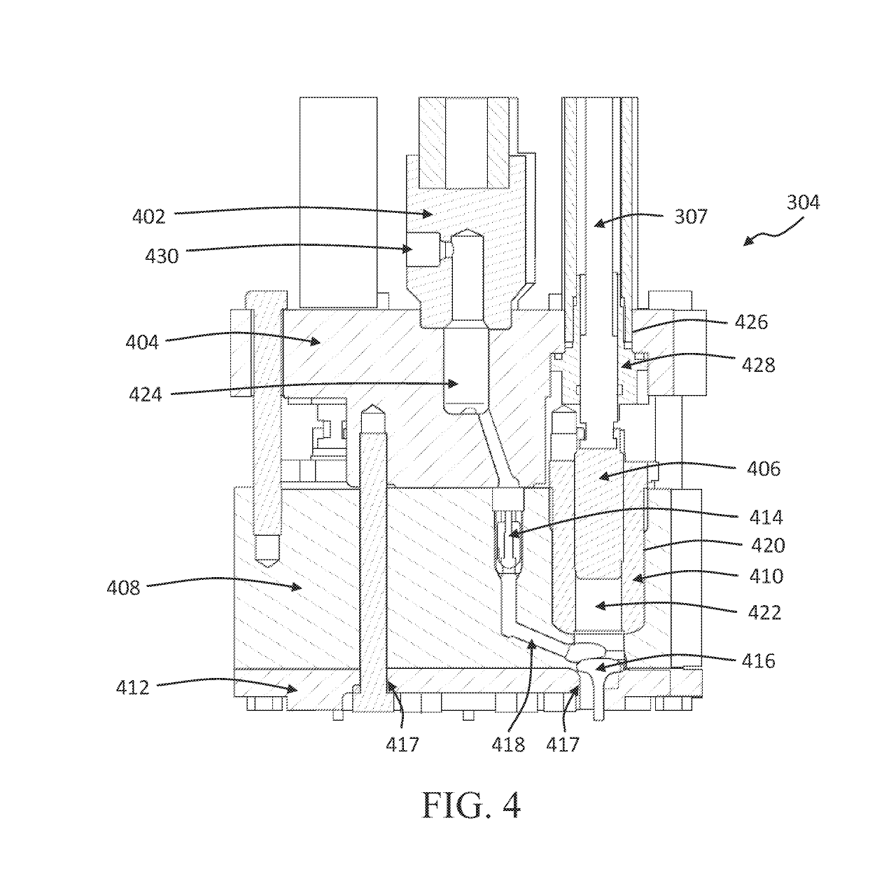

FIG. 4 illustrates a cross sectional side view of the pumping mechanism end 304 of the fuel pump 300, according to an aspect of this disclosure. The pumping mechanism end 304 of the fuel pump 300 may include a discharge member 402, a connecting flange 404, a plunger 406, a barrel housing 408, a barrel insert 410, a barrel head 412, a discharge check valve 414, and an inlet check valve 416. The barrel head 412 may be coupled to the barrel housing 408 and may include at least one opening 417. The at least one opening 417 may be configured to receive the inlet check valve 416 configured to control the fuel flow into the fuel pump 300. The at least one opening 417 may also be used to receive a securing mechanism, such as bolts or screws, to secure the barrel head 412 to the pumping mechanism end 304 of the fuel pump 300.

The barrel housing 408 may be coupled to the connecting flange 404 and may define a first fuel channel 418 and an insert passage 420. The insert passage 420 may be configured to receive the barrel insert 410 within. The barrel insert 410 defines a fuel chamber 422 configured to receive fuel within. The barrel insert 410 is configured to slideably receive the plunger 406 within. The first fuel channel 418 may fluidly couple both the inlet check valve 416 and the fuel chamber 422 to the discharge check valve 414. In an aspect of this disclosure, the barrel insert 410 is optional, whereby the fuel chamber 422 may be machined directly into the barrel housing 408 and configured to slideably receive the plunger 406.

The connecting flange 404 may be coupled to the discharge member 402 and may define a second fuel channel 424 and a guide passage 426. The guide passage 426 may be configured to receive a guide nut 428 within. The guide nut 428 may be configured to slideably receive one of the connecting rods 307 within. The second fuel channel 424 may fluidly communicate with the first fuel channel 418 via the discharge check valve 414.

The discharge member 402 may define a discharge port 430. The discharge member 402 may be aligned with the connecting flange 404 such that the discharge port 430 is in fluid communication with the second fuel channel 424. The discharge port 430 may be fluidly coupled to the second fuel conduit 233.

The one or more connecting rods 307 may be coupled, either directly or indirectly, to the plunger 406. The reciprocating force transmitted by the connecting rods 307 from the pump drive system 308 slideably translates the plunger 406 within the fuel chamber 422. The movement of the plunger 406 causes fuel to enter the fuel chamber 422 through the inlet check valve 416 and to exit the fuel chamber 422 through the discharge check valve 414 via the first fuel channel 418. It will be appreciated that for each connecting rod 307, a corresponding plunger 406, barrel insert 410, discharge check valve 414, and inlet check valve 416 may be operatively coupled thereto forming a pumping element.

The fuel chamber 422 defines a pump volume. The pump volume increases and decreases in size while the reciprocating force transmitted by the connecting rods 307 translates the plunger 406 within the fuel chamber 422. The fuel chamber 422 defines a maximum pump displacement volume when the plunger 406 is positioned at an uppermost end of the fuel chamber 422 (i.e. fully retracted position) and the fuel chamber 422 defines a minimum pump displacement volume when the plunger 406 is positioned at a bottommost end of the fuel chamber 422 (i.e. fully extended position). A difference between the maximum pump displacement volume and the minimum pump displacement volume may be referred to as a pump displacement. For every pump displacement from the minimum pump volume to the maximum pump volume, an input mass of fuel is pumped into the fuel chamber 422. For every pump displacement from the maximum pump volume to the minimum pump volume, an output mass of fuel is pumped into the second fuel conduit 233. The terms “above” and “below,” as used herein, describe the positions of certain components relative to one another as shown in the illustrated embodiments and are thus approximations to simplify discussion of the present disclosure. The terms “above”, “upper”, or “uppermost” refer to a position that is closer to an uppermost portion of the fuel pump 300, such as the first end 302, and the terms “below”, “bottom”, or “bottommost” mean a position closer to a bottommost portion of the fuel pump 300, such as the second end 304 of the fuel pump 300. However, as should be apparent, the fuel pump 300 need not be mounted vertically as shown in the figures, buy may also be mounted horizontally or obliquely to a surface or plane of the machine 100.

The fuel pump 300 may include a first pump stage and a second pump stage. At the first pump stage, the pump 300 may define the maximum pump displacement volume and at the second pump stage, the pump 300 may define the minimum pump displacement volume. As the pump 300 transitions from the first pump stage to the second pump stage the fuel in the second fuel conduit 233 transitions from a first fuel pressure to a second fuel pressure, defining a pressure pulse of fuel within the second fuel conduit 233.

In an aspect of this disclosure, the pump displacement is set to a value based on an amplitude of the pressure pulse of the fuel within the second fuel conduit 233. The amplitude of the pressure pulse may be predetermined and/or selected based on a variety of factors including, for example, minimizing the size of an accumulator, eliminating the need for an accumulator, eliminating the need for a fuel regulator, combinations thereof, or for other reasons.

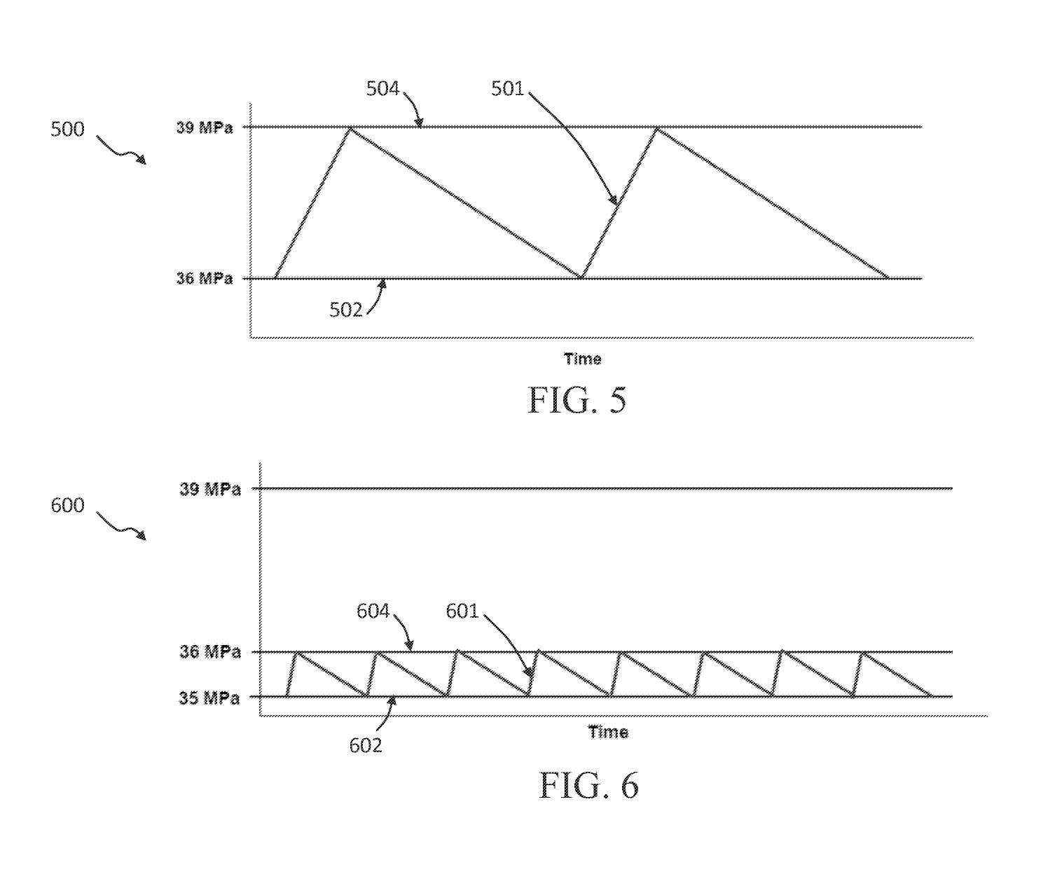

FIGS. 5 and 6 depict a first graph 500 and a second graph 600, respectively, which illustrate two examples of pressure pulses of a fuel within the second fuel conduit 233. Referring to FIG. 5, the first graph 500 depicts the pressure of the fuel within the second fuel conduit 233 having a first pressure pulse 501 that ranges from a first fuel pressure 502 to a second fuel pressure 504. For each pump displacement from the maximum pump volume to the minimum pump volume, the pressure of the fuel within the second fuel conduit 233 may move from the first fuel pressure 502 to the second fuel pressure 504, and for each pump displacement from the minimum pump volume to the maximum pump volume, the pressure of the fuel within the second fuel conduit 233 may move from the second fuel pressure 504 to the first fuel pressure 502. This may occur continuously during the operation of the fuel system 200. According to the aspect depicted, the first fuel pressure 502 is 36 MPa and the second fuel pressure 504 is 39 MPa, resulting in the amplitude of the first pressure pulse 501 of 3 MPa.

Referring to FIG. 6, the second graph 600 depicts another example of the pressure of the fuel within the second fuel conduit 233 having a second pressure pulse 601 that ranges from a third fuel pressure 602 to a fourth fuel pressure 604. For each pump displacement from the maximum pump volume to the minimum pump volume, the pressure of the fuel within the second fuel conduit 233 moves from the third fuel pressure 602 to the fourth fuel pressure 604. For each pump displacement from the minimum pump volume to the maximum pump volume, the pressure of the fuel within the second fuel conduit 233 moves from the fourth fuel pressure 604 to the third fuel pressure 602. According to the aspect depicted in the second graph 600, the third fuel pressure 602 is 35 MPa and the fourth fuel pressure 604 is 36 MPa, resulting in the second pressure pulse 601 having an amplitude of 1 MPa.

In an aspect of this disclosure, the amplitude of the pressure pulse is further selected based on whether the amplitude is low enough for the fuel system 200 to not require a regulator positioned along the second fuel conduit 233 to control fuel pressure. This may depend on the capability of the injector and control systems of the fuel system 200 to compensate for deviations in fuel pressure. Therefore, either the first or the second pressure pulse 501, 601 depicted in the first and second graph 500, 600 may be selected and used by the controller 118 to control the fuel pump 300 depending on the capability of the fuel system 200.

The amplitude of the pressure pulse may be reduced by increasing the accumulator volume or by reducing the mass flow rate of fuel through the second fuel conduit 233. In an aspect of this disclosure, the accumulator may be removed from the fuel system 200 and the second fuel conduit 233 may represent the accumulator. Therefore, if the second fuel conduit 233 has already been positioned within the fuel system 200, then to reduce the amplitude of the pressure pulse, the mass flow rate may be reduced. For example, if the second pressure pulse 601 is the desired pressure pulse for the fuel system 200, but the actual pressure pulse of the fuel system 200 is higher, such as the first pressure pulse 501, then reducing the output mass of fuel from the pump 300 may reduce the amplitude of the pressure pulse. The output mass of fuel may be reduced by reducing the pump displacement of the fuel pump 300.

In an aspect of this disclosure, the volume of the second fuel conduit 233 is predetermined and the amplitude of the pressure pulse for the fuel within the second fuel conduit 233 is predetermined. Therefore, the pump displacement of the fuel pump 300 may be set to a value defined by a ratio of the output mass of fuel per the predetermined volume of the second fuel conduit 233 that is needed to maintain the predetermined pressure pulse of the fuel within the second fuel conduit 233.

### INDUSTRIAL APPLICABILITY

Referring to FIGS. 1-4, the present disclosure provides a system and method configured to determine the pump displacement of the fuel pump 300 configured to pump fuel to the engine 110. To minimize the number of components along the second fuel conduit 233, the pump displacement may be set to a value based on a predetermined pressure pulse of the fuel within the second fuel conduit 233, and further based on the output mass of fuel per the volume of the second fuel conduit 233.

In determining the pump displacement of the fuel pump 300, a Redlich-Kwong-Soave (RKS) equation of state model of real gas may be used to simulate the operation of the fuel pump 300. The RKS model simulates real gas behavior and simulates the heat transfer between the fuel entering the second fuel conduit 233 and the fuel within the second fuel conduit 233.

In using the RKS model, a desired pressure pulse amplitude and a volume of the second fuel conduit 233 may be selected. The desired pressure pulse amplitude may be selected to eliminate the need for a fuel regulator and the volume of the second fuel conduit 233 may be selected to eliminate the need for an accumulator. However, in other aspects, the desired pressure pulse amplitude and the volume of the second fuel conduit 233 may be selected for other reasons.

In addition to the desired pressure pulse amplitude and the volume of the second fuel conduit 233, the fuel temperature of the fuel entering the second fuel conduit 233, the fuel temperature of the fuel within the second fuel conduit 233, and an engine operating condition may be selected. In an aspect of this disclosure, the selection of the fuel temperatures may be based on an initial condition with a large difference between the fuel temperature entering the second fuel conduit 233 and the fuel temperature within the second fuel conduit 233.

The engine operating condition may be a combination of a desired pressure within the second fuel conduit 233 and a consumption rate of fuel out of the fuel system 200. In an aspect of this disclosure, the engine operating condition with the largest pressure rise per fuel mass injection into the second fuel conduit 233 is selected. For example, this may be an engine operating condition which results in the least fuel flow out of the second fuel conduit 233 while the fuel pressure within the second fuel conduit 233 is at the highest.

After each of the above mentioned parameters has been selected, the RKS model may be used to determine the amount of fuel mass it takes to raise the pressure of the fuel within the second fuel conduit 233 by the predetermined pressure pulse amplitude. Based on the amount of fuel mass it takes to raise the pressure of the fuel, the pump displacement of the fuel pump 300 may be determined.

An example of the sizing of the pump displacement of the fuel pump 300 may include the following conditions.
Desired Pressure Pulse Amplitude: 1 MPa
Accumulator (or Fuel Conduit) Volume: 10 L
Initial Accumulator (or Fuel Conduit) Temperature: 20° C.
Fuel Temperature Entering Accumulator (or Fuel Conduit): 60° C.
   Using an RKS model with each of these parameters as input, a sweep mass per stroke may be calculated to equal approximately 18.18 grams. This results in a 1.818 g/L pump stroke mass per accumulator volume. Additionally, if the density of the fuel is 400 kg/m³, for example, then the pump displacement of an individual pumping element may be less than 0.0455 L (18.18/400 kg/m³). In an aspect of this disclosure, a range of output mass of fuel per accumulator volume may be between 0.9 g/L and 3.6 g/L, with a tolerance between approximately 0.1 g/L and 0.3 g/L.

The output mass of fuel per accumulator volume may be used with other pump requirements, such as piston velocity, flow rate, and efficiency, to define a bore, a stroke, and a number of pumping elements required for the fuel pump 300.

It will be appreciated that the foregoing description provides examples of the disclosed system and method. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

We claim:

1. A fuel system comprising:
a conduit having a conduit volume, the conduit configured to contain a fuel at a first fuel pressure and a second fuel pressure that is different from the first fuel pressure; and
a pump fluidly coupled to the conduit, the pump including a first pump stage in which the pump defines a maximum pump displacement and a second pump stage in which the pump defines a minimum pump displacement, the pump being configured to provide an output mass of fuel to the conduit when the pump transitions from the first pump stage to the second pump stage, wherein for each transition from the first pump stage to the second pump stage the fuel in the conduit transitions from the first fuel pressure to the second fuel pressure, wherein a difference between the first fuel pressure and the second fuel pressure defines a pressure pulse,
wherein the maximum pump displacement is set to a value defined by a ratio of the output mass of fuel per the conduit volume needed to maintain the pressure pulse within a predetermined pressure pulse range.

2. The fuel system of claim 1, wherein the output mass of fuel per the conduit volume is greater than or equal to 0.9 g/L.

3. The fuel system of claim 2, wherein the output mass of fuel per the conduit volume is less than or equal to 3.6 g/L.

4. The fuel system of claim 1, wherein the conduit fluidly couples the pump to an engine.

5. The fuel system of claim 1, wherein the conduit volume is predetermined.

6. The fuel system of claim 1, wherein the pump includes a plurality of pumping elements, wherein each of the plurality of pumping elements has a maximum pump element displacement, wherein each of the maximum pump element displacements compose the maximum pump displacement.

7. The fuel system of claim 6, wherein the maximum pump displacement is less than 0.0455 L.

8. The fuel system of claim 1, wherein the fuel is liquefied natural gas.

9. The fuel system of claim 8, wherein the pump is a liquefied natural gas cryogenic pump.

10. The fuel system of claim 1, wherein a Redlich-Kwong-Soave equation of state is used to determine the output mass of fuel per the conduit volume by correlating the first fuel pressure and the second fuel pressure.

11. A fuel system comprising:
an engine;
a conduit having a conduit volume, the conduit fluidly coupled to the engine and configured to contain a fuel at a first fuel pressure and a second fuel pressure that is different from the first fuel pressure; and
a pump fluidly coupled to the conduit, the pump including a first pump stage in which the pump defines a maximum pump displacement and a second pump stage in which the pump defines a minimum pump displacement, the pump being configured to provide an output mass of fuel to the conduit when the pump transitions from the first pump stage to the second pump stage, wherein for each transition from the first pump stage to the second pump stage the fuel in the conduit transitions from the first fuel pressure to the second fuel pressure, wherein a difference between the first fuel pressure and the second fuel pressure defines a pressure pulse,
wherein the maximum pump displacement is set to a value defined by a ratio of the output mass of fuel per the conduit volume needed to maintain the pressure pulse within a predetermined pressure pulse range.

12. The fuel system of claim 11, further comprising an accumulator fluidly coupled between the engine and the pump.

13. The fuel system of claim 11, further comprising an engine injector coupled to an inlet of the engine, wherein the conduit is configured to fluidly couple the pump directly to the engine injector.

14. The fuel system of claim 11, wherein the conduit volume is substantially equivalent to an entire fuel volume between the pump and the engine.

15. The fuel system of claim 11, wherein the predetermined pressure pulse is based on a capability of the engine injector.

16. The fuel system of claim 11, further comprising a fuel tank fluidly coupled to the pump, wherein the pump is submerged within the fuel tank.

17. The fuel system of claim 11, wherein the pump is a liquefied natural gas cryogenic pump.

18. A machine comprising:
an engine; and
a fuel system fluidly coupled to the engine, the fuel system including:
a conduit having a conduit volume, the conduit fluidly coupled to the engine and configured to contain a fuel at a first fuel pressure and a second fuel pressure that is different from the first fuel pressure; and
a pump fluidly coupled to the conduit, the pump including a first pump stage in which the pump defines a maximum pump displacement and a second pump stage in which the pump defines a minimum pump displacement, the pump being configured to provide an output mass of fuel to the conduit when the pump transitions from the first pump stage to the second pump stage, wherein for each transition from the first pump stage to the second pump stage the fuel in the conduit transitions from the first fuel pressure to the second fuel pressure, wherein a difference between the first fuel pressure and the second fuel pressure defines a pressure pulse,
wherein the maximum pump displacement is set to a value defined by a ratio of the output mass of fuel per the conduit volume needed to maintain the pressure pulse within a predetermined pressure pulse range.

19. The machine of claim 18, wherein the output mass of fuel per conduit volume is greater than or equal to 0.9 g/L, and wherein the output mass of fuel per conduit volume is less than or equal to 3.6 g/L.

20. The machine of claim 18, wherein the machine is a mining truck.
